(19) United States
(12) Patent Application Publication
(10) Pub. No.: US 2008/0248723 A1
(43) Pub. Date: Oct. 9, 2008

(54) Polishing condition control apparatus and polishing condition control method of CMP apparatus

(75) Inventors: Toshiyuki Yokoyama, Tokyo (JP); Takashi Fujita, Tokyo (JP); Katsunori Tanaka, Tokyo (JP)

Correspondence Address: PAUL A. FATTIBENE;FATTIBENE & FATTIBENE, 2480 POST ROAD, SOUTHPORT, CT, 06890, US

(73) Assignee: TOKYO SEIMITSU CO., LTD.

(21) Appl. No.: 12/080,200

(22) Filed: Apr. 1, 2008

(30) Foreign Application Priority Data
Apr. 7, 2007 (JP) 2007-101200

(51) Int. Cl. B24B 49/03; B24B 51/00; G06F 19/00

(52) U.S. Cl. 451/5; 451/8; 700/121; 700/164

(57) ABSTRACT

To eliminate the unevenness of the film thickness of the wafers, and increase the polishing efficiency, reduce the running cost and enhance the production yield. A CMP apparatus 1 includes a film thickness measuring means 6 that measures the film thickness of the wafers before polishing, a polishing recipe preparing means 7 that prepares polishing conditions so that the polishing conditions such as polishing speed, polishing pressure, and the like for the wafers become optimal, a polishing time forecasting means that forecasts the polishing time of the wafer on the basis of the optimal polishing condition and the measured value, a polishing time measuring means that measures the actual polishing time of the wafer, and a computer 9 that controls the polishing condition on the basis of the measured value and the like of the polishing time. Further, the computer 9 includes a calculating unit 23 that calculate the difference between the measured value of the polishing time and the forecasted value thereof, and a polishing condition correcting/changing unit 24 that corrects/changes the polishing conditions so that the calculated difference becomes minimal, and thereby, the correction/change of the polishing conditions is carried out in real time.

### BACKGROUND OF THE INVENTION

1. Field of the Invention

The present invention relates to a polishing condition control apparatus and a polishing condition control method of a CMP apparatus, and particularly, it relates to a polishing condition control apparatus and a polishing condition control method of a CMP apparatus for optimizing the polishing condition of a wafer.

2. Description of the Related Art

In recent years, the design rules of semiconductor technologies have become toward ultrafine configurations and multilayer wiring, and the diameter of wafers has become larger, and consequently in the CMP process, requirements for polishing precision and polishing speed have become severer. In addition, for example, in the wafer of the Cu damascene structure, a Cu film which is a wiring film is formed on the wafer surface, and a barrier film such as a Ta film or a Ti film or the like is formed under the Cu film, and further, an oxide film and a low dielectric constant insulation film are formed under the barrier film.

Therefore, in the CMP process, after the Cu film is polished and removed first, it is necessary to polish and remove the barrier film. That is, in the first polishing step, at the moment when the Cu film is removed and the barrier film is exposed, the procedure shifts to the second polishing step to remove the barrier film. In this case, in the first polishing step, an abrasive whose polishing rate to the Cu film is large is used, and, in the second polishing step, an abrasive whose polishing rate to the barrier film is large is used.

Conventionally, in polishing a wafer by this kind of CMP apparatus, a platen is rotated by a motor, and an abrasive is supplied onto an polishing pad stuck to the platen, and the wafer is pushed to the polishing pad while rotating the wafer held by a polishing head, and thereby films to be polished including the oxide film, the metal film and the like formed on the wafer surface are polished.

In the above CMP process, the thickness of residual film of the wafer surface (hereinafter, referred to as film thickness) is measured by use of a film thickness monitor means, and the wafer is polished so as for the film thickness to become the target value. In this case, the film thickness is measured by the vertical direction displacement of the polishing pad. In addition, there are known a method in which the CMP process is performed by a simple feedback control of the film thickness measurement, and another method in which the state of the wafer polishing is monitored by a monitor, and the polishing state of the wafers to be polished afterward is forecasted and polishing is performed (refer to, for example, Patent Documents 1 to 3).

[Patent Document 1] Japanese Patent No. 308285

[Patent Document 2] Japanese Patent No. 3311864

[Patent Document 3] Japanese Patent Application Laid-Open Publication No. 2005-518654

In the conventional CMP apparatus, in the case where the film thickness of the wafer is measured by the vertical direction displacement of the polishing pad, it is difficult to obtain a stable result of the film thickness measurement, and consequently, it is not possible to perform a highly precise polishing process. Further, in the case where the CMP process is performed by the simple feedback control of the film thickness measurement, it is not possible to obtain a highly precise film thickness measurement, and consequently, the method does not cope with ultrafine and highly integrated wafers sufficiently.

On the other hand, in the case where the state of the wafer polishing is monitored by a monitor, and the polishing state of the wafers to be polished afterward is forecasted and polishing is performed, the polishing process conditions differ with the respective modules of the apparatus, that is, respective rotating axes of the polishing head (hereinafter referred to as polishing axes), and respective platens, and as a result, the film thickness of wafers after the polishing process is apt to be uneven among the modules.

As mentioned above, according to the prior art, unevenness in the film thickness of the wafers occurs among the modules. In addition, excessive polishing and insufficient polishing easily take place, and polishing efficiency of the wafer declines, and defects occur in wafers after the polishing, and the production yield decreases. Furthermore, expendable supplies such as abrasives are wasted more than necessary, and accordingly the running cost of the expendable supplies increases, and these have been problems in the prior art.

### SUMMARY OF THE INVENTION

Therefore, there has been a technological subject to eliminate the unevenness of the film thickness of the wafers, and, increase the polishing efficiency, reduce the running cost and enhance the production yield, and accordingly, it is the object of the present invention to solve the problems.

The present invention has been made to achieve the above object, and according to a first aspect of the present invention, there is provided a polishing condition control apparatus of a CMP apparatus that polishes a film to be polished formed on the surface of a wafer, and the polishing condition control apparatus includes: a film thickness monitoring means that measures the film thickness of the above wafer before polishing; a polishing recipe preparing means that prepares polishing conditions so that the polishing conditions such as polishing speed, polishing pressure, and an abrasive and the like for the wafer become optimal; a polishing time forecasting means that forecasts the polishing time of the wafer to be polished under the polishing conditions on the basis of the above measured value of the film thickness; a polishing time measuring means that measures the polishing time of the wafer polished under the above polishing conditions; and a computer that controls the measurement results of the polishing time and the above polishing conditions, and further the computer includes a calculating unit that calculate the difference between the measured value of the above polishing time and the forecasted value thereof, and a polishing condition correcting/changing unit that corrects/changes the above polishing conditions so that the calculated difference becomes minimal, and thereby, the correction/change of the polishing conditions is carried out in real time.

According to this structure, the film thickness of the wafer before the polishing is measured by the film thickness monitoring means. In addition, the polishing conditions are prepared by the polishing recipe preparing means so that the polishing conditions such as polishing speed, polishing pressure, abrasives and the like become optimal. Further, the polishing time forecasting means forecasts the polishing time for the wafer polished under the optimal polishing conditions on the basis of the above measured value of the film thickness.

And, the actual polishing time of the wafer polished under the above polishing conditions is measured by the polishing time measuring means, and the difference (including a modulus difference or a deviation) between the measured value of the polishing time and the forecasted value thereof is calculated by the above calculating unit. Subsequently, when the calculated difference exceeds a predetermined value, the polishing conditions are corrected/changed by the polishing condition correcting/changing unit in real time so that the difference becomes minimal. Thus, wafers after the next time are always processed into the target film thickness under the optimal polishing conditions.

According to a second aspect of the present invention, there is provided a polishing condition control apparatus of a CMP apparatus according to the first aspect of the present invention, wherein the above polishing recipe preparing means prepares the optimal polishing conditions for each polishing step of the above wafer, each polishing shaft of the above CMP apparatus, each platen, or each combination of the polishing shaft and the platen.

According to this structure, the optimal polishing conditions are prepared for each polishing step of the wafer, each polishing shaft of the CMP apparatus, each platen, or each combination of the polishing shaft and the platen. Therefore, the wafers are polished under the optimal polishing conditions corresponding to each individual polishing step, polishing shaft, or platen.

According to a third aspect of the present invention, there is provided a polishing condition control apparatus of a CMP apparatus according to the first or second aspect of the invention, wherein the above polishing recipe preparing means prepares the optimal polishing conditions on the basis of data of an approximate expression prepared from past polishing history and/or a polishing model that the above CMP apparatus itself stores beforehand.

According to this structure, in the preparation of the above polishing conditions, the data of the approximate expression prepared from past polishing history and/or the polishing model that the CMP apparatus itself stores beforehand are used. Therefore, the polishing conditions that reflect the data of the past polishing history and/or the polishing model peculiar to the apparatus are prepared. The polishing model is a model showing the relations between the polishing parameters such as the polishing pressure and the polishing time and the polishing quantity that are made into fixed quantities and numerical values.

According to a fourth aspect of the present invention, there is provided a polishing condition control apparatus of a CMP apparatus according to the first aspect of the invention, wherein the above polishing time forecasting means forecasts the above polishing time of the wafer on the basis of data of an approximate expression prepared from past polishing history and/or a polishing model that the above CMP apparatus itself stores beforehand.

According to this structure, the polishing time is forecasted on the basis of the data of the approximate expression prepared from the past polishing history and/or the polishing model that the above CMP apparatus itself stores beforehand, and accordingly, after an initial film thickness distribution measurement, the forecasted value of the polishing time is obtained, on the basis of only the measurement result.

According to a fifth aspect of the present invention, there is provided a polishing condition control apparatus of a CMP apparatus according to the first aspect of the invention, wherein the above computer has a monitoring unit that displays the difference between the measured value of the above polishing time and the forecasted value thereof, and polishing states of the above wafers and the like.

According to this structure, the difference between the above measured value of the polishing time and the above forecasted value thereof, and polishing states of the wafers and the like are monitored and grasped by the monitoring unit in real time.

According to a sixth aspect of the present invention, there is provided a polishing condition control apparatus of a CMP apparatus according to the first or fifth aspect of the invention, wherein the above computer includes a polishing state judging unit that outputs an attention signal, an alarm signal and/or a polishing stop signal, when the difference between the above measured value of the polishing time and the above forecasted value thereof exceeds a predetermined value.

According to this structure, when the difference between the above measured value of the polishing time and the above forecasted value thereof exceeds over the predetermined value, the attention signal, the alarm signal and/or the polishing stop signal are output. Accordingly, when the polishing state gets erroneous, the effect to that is automatically notified, and at an emergency, the polishing processing is stopped immediately.

According to a seventh aspect of the present invention, there is provided a polishing condition control apparatus of a CMP apparatus according to the first aspect of the invention, wherein the above polishing condition correcting/changing unit corrects/changes the polishing conditions for each polishing step of the above wafer, each polishing shaft of the above CMP apparatus, each platen, or each combination of the polishing shaft and the platen.

According to this structure, the correction/change of the polishing conditions is performed independently for each polishing step of the above wafer, each polishing shaft of the above CMP apparatus, each platen, or each combination of the polishing shaft and the platen. Therefore, the polishing conditions are corrected/changed to the optimal polishing conditions for each polishing step, and further, the optimal polishing conditions are corrected/changed in the same manner among the polishing shafts, the platens, or, the combinations of the polishing shaft and the platen.

According to an eighth aspect of the present invention, there is provided a polishing condition control method of a CMP apparatus that polishes a film to be polished formed on the surface of a wafer, and the polishing condition control method includes, a film thickness monitoring step of measuring the film thickness of the above wafer before polishing, a polishing recipe preparing step of preparing polishing conditions so that the polishing conditions such as polishing speed, polishing pressure, and an abrasive and the like for the wafer become optimal, a polishing time forecasting step of forecasting the polishing time of the wafer to be polished under the polishing conditions on the basis of the above measured value of the film thickness, a polishing time measuring step of measuring the polishing time of the wafer polished under the above polishing conditions a calculating step of calculating difference between the measured value of the polishing time and forecasted value, and a polishing condition correcting/changing step of correcting/changing the above polishing conditions so that the calculated difference becomes minimal, and thereby, the correction/change of the polishing conditions is carried out in real time.

According to this method, the film thickness of the wafer is measured before the polishing, and the polishing conditions are so prepared that the polishing conditions such as polishing speed, polishing pressure, abrasives and the like become optimal. Further, the polishing time for the wafer polished under the polishing conditions is forecasted on the basis of the above measured value. And the actual polishing time of the wafer is measured, and the difference (including a modulus difference or a deviation) between the measured value of the polishing time and the forecasted value thereof is calculated, subsequently, when the calculated difference exceeds a predetermined value, the polishing conditions are corrected/changed in real time so that the difference becomes minimal. Thus, wafers are always polished under the optimal polishing conditions, and the film thickness of the wafers is processed into the target value.

According to the first aspect of the present invention, the polishing conditions such as the polishing speed, the polishing pressure, the flow quantity of abrasives and the like can be always maintained optimally, and accordingly, it is possible to eliminate the unevenness in the film thickness of the wafers after the polishing, and improve the polishing efficiency, and reduce running costs (wastes of abrasives and the like). In addition, since the occurrence of defective products can be prevented, the production yield can be enhanced.

According to the second aspect of the present invention, since the optimal polishing conditions according to individual polishing step, polishing shaft or platen can be prepared, in addition to the effect of the first aspect, it is possible to polish the film thickness of the wafers into the target value efficiently.

According to the third aspect of the present invention, since the polishing conditions that reflect the data of the past polishing history and/or the polishing model peculiar to the apparatus can be prepared, in addition to the effect of the first or second aspect, it is possible to improve the polishing precision of the wafers.

According to the fourth aspect of the present invention, since the polishing time of the wafer is forecasted on the basis of the data of the past polishing history and/or the data of the polishing model peculiar to the apparatus, in addition to the effect of the first aspect, it is possible to forecast the polishing time more precisely.

According to the fifth aspect of the present invention, since the difference between the above measured value of the polishing time and the forecasted value thereof, and the polishing states of the wafers and the like can be monitored in real time, in addition to the effect of the first aspect, it is possible to check the polishing states of the wafers according to the specifications of the wafers and the polishing environment at any time.

According to the sixth aspect of the present invention, when the polishing state gets erroneous, the effect to that is automatically notified, and at an emergency, the polishing process is stopped immediately, and accordingly, in addition to the effect of the first or fifth aspect, it is possible to prevent the wafer from being polished and processes in an erroneous state.

According to the seventh aspect of the present invention, since the optimal polishing conditions for each polishing step of the above wafer, each polishing shaft, and/or each platen can be set in common, and accordingly, in addition to the effect of the first aspect, it is possible to eliminate the unevenness of the film thickness of wafers among the individual polishing steps, the polishing shafts and/or the platens.

According to the eighth aspect of the present invention, when the wafers are polished, the polishing conditions such as the polishing speed, the polishing pressure, the flow quantity of abrasives can be corrected/changed optimally, and accordingly, it is possible to improve the polishing precision of the film thickness of the wafers, and the unevenness of the film thickness of the wafers can be eliminated, and further increase of the polishing efficiency, and reduction of the running costs (the wastes of abrasives and the like) are achieved. Furthermore, excessive polishing and insufficient polishing are eliminated, and the occurrence of defective products can be reduced in comparison with the prior art, and accordingly, it is possible to enhance the production yield.

### BRIEF DESCRIPTION OF THE DRAWINGS

FIG. 1 is a top plan view showing a total structure of a CMP apparatus according to an embodiment of the present invention;

FIG. 2 is a block diagram showing the CMP apparatus according to an embodiment;

FIG. 3 is a perspective view showing a polishing unit of the CMP apparatus according to an embodiment;

FIG. 4 is a flow chart for explaining the procedure of a polishing condition control according to an embodiment;

FIG. 5 show graphs for explaining an EPD time according to an embodiment, and 5A shows a graph for explaining the permissible range of the EPD time to the number of polishing, and 5B shows a graph for explaining a forecasted polishing time of the EPD; and

FIG. 6 show graphs for explaining a polishing model according to an embodiment, and 6A is a graph showing the relation between the polishing pressure and the polishing speed, 8B is a graph showing the relation between the polishing time and the polishing quantity, and 8C is a graph for explaining changes of the polishing pressure when the polishing speed declines by 10%.

### DESCRIPTION OF PREFERRED EMBODIMENTS

In order to achieve the object to eliminate the unevenness of the film thickness of the wafers, and, increase the polishing efficiency, reduce the running cost and enhance the production yield, the present invention is embodied by that in a CMP apparatus that polishes a film to be polished formed on the surface of a wafer, a film thickness monitoring means that measures the film thickness of the above wafer before polishing, a polishing recipe preparing means to make polishing conditions so that the polishing conditions such as polishing speed, polishing pressure, and an abrasive and the like for the wafer become optimal, a polishing time forecasting means that forecasts the polishing time of the wafer to be polished under the polishing conditions on the basis of the above measured value of the film thickness, a polishing time measuring means that measures the polishing time of the wafer polished under the above polishing conditions, and a computer that controls the measurement results of the polishing time and the above polishing conditions are structured of, and further, the computer includes a calculating unit that calculate the difference between the measured value of the above polishing time and the forecasted value thereof, and a polishing condition correcting/changing unit that corrects/changes the above polishing conditions so that the calculated difference becomes minimal, and thereby, the correction/change of the polishing conditions is carried out in real time.

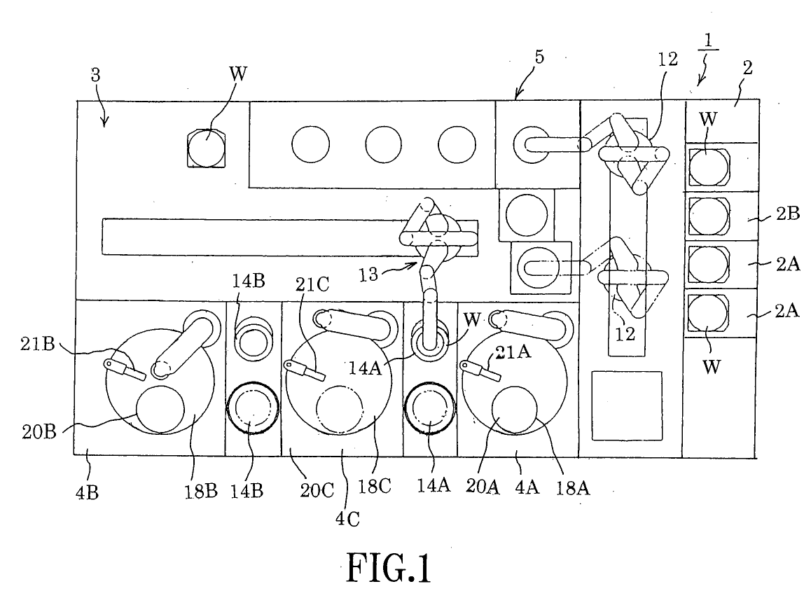

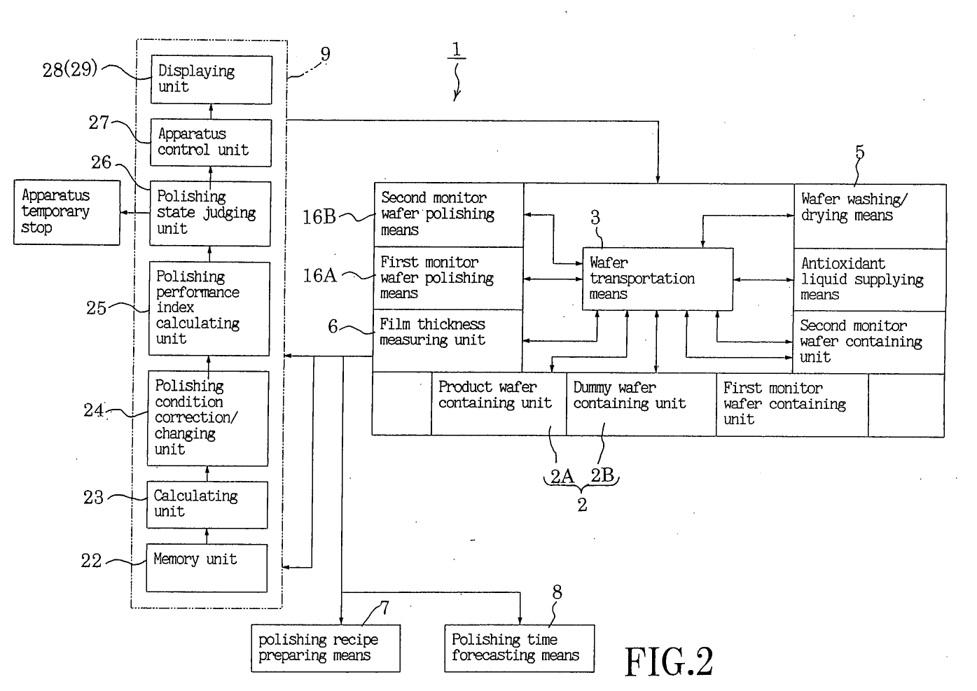

Hereinafter, an embodiment according to the present invention is explained with reference to FIG. 1 through FIG. 6. The present embodiment is applied to a CMP apparatus that polishes a kind or two or more kinds of films to be polished, and before rough polishing or finish polishing of the wafers, the film thickness of the wafers are measured and the optimal polishing conditions are prepared, and the polishing time of the wafers is forecasted on the basis of the polishing conditions and the measured value, and further, the actual polishing time of the wafers is measured, and the polishing conditions are corrected/changed in real time so that the difference between the measured value and the forecasted value becomes minimal, and thereby, wafers after the next time are always polished under the optimal polishing conditions. Meanwhile, wafers to become polishing objectives may or may not have a pattern film thereon.

The data of the polishing time and the polishing quantity and the like acquired by the polishing process of wafers are controlled for each polishing step, or each polishing shaft and/or each platen, the polishing conditions are corrected/changed immediately so that the polishing quantity of the wafers becomes the target value. Furthermore, the plurality of polishing conditions are always monitored optionally selectively, meanwhile, other polishing conditions that are not monitored can be also corrected/changed. For example, in the CMP, when polishing is carried out at the rough polishing step and the finish polishing step, from the polishing time and the polishing model obtained in the finish step, the polishing conditions of the rough polishing are calculated.

In addition, when an appropriate polishing time or polishing rate is to be obtained, the appropriate polishing time or polishing rate can be calculated by inserting the measured value into, for example, the relational expression of the polishing time and the polishing rate, or the relational expression of the main polishing time or polishing pressure and the subsidiary polishing time or polishing pressure. On the basis of this calculation result, the rough polishing conditions and/or the rough polishing time, and the finish polishing conditions and/or the finish polishing time are corrected/changed appropriately, and the corrections/changes can be reflected to the polishing conditions thereafter.

As shown in FIG. 1 and FIG. 2, a CMP apparatus 1 includes a wafer containing unit 2, a transportation means 3, polishing means (the apparatus main body units) 4A, 4B and 4C, a washing/drying means 5, a film thickness (measuring) monitoring means 6, a polishing recipe preparing means 7, a polishing time forecasting means 8, a computer 9, and an apparatus control unit 10 and the like. The wafer containing unit 2 comprises a wafer containing unit 2A and a dummy wafer containing unit 2B and the like. In addition, the transportation means 3 comprises an index robot 12, a transfer robot 13, and transportation units 14A and 14B.

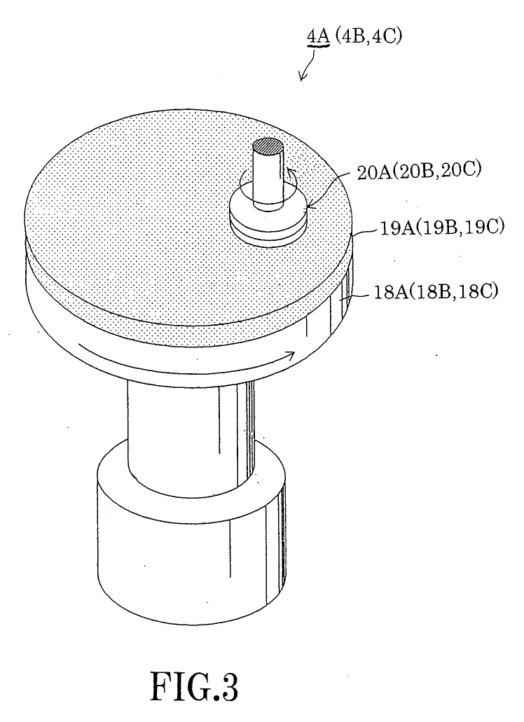

The polishing means 4A, 4B and 4C, include rotatable platens 18A, 18B and 18C, polishing pads 19A, 19B and 19C attached to the platens 18A, 18B and 18C, polishing heads 20A, 20B and 20C that push the wafers to the polishing pads 19A, 19B and 19C, and nozzles 21A, 21B and 21C that supply an abrasive to the upper surfaces of the polishing pads 19A, 19B and 19C (refer to FIG. 3). The left and right platens 18A and 18B are used for the polishing of a first film to be polished, and the central platen 18C is used for the polishing of a second film to be polished. The polishing conditions are different each other on the polishing of the first film to be polished and the polishing of the second film to be polished, and the kinds or components of abrasives, the rotation speeds of the polishing heads 20A, 20B and 20C and the rotation speeds of the platens 18A, 18B and 18 C, the pressing forces of the polishing heads 20A, 20B and 20C, and the kinds of the polishing pads 19A, 19B and 19C and the like are changed in the polishing.

The polishing condition control apparatus according to the present embodiment includes a film thickness monitoring means 6, a polishing recipe preparing means 7, a polishing time forecasting means 8, and a computer 9, and it is structured so as to perform the correction/change of the optimal polishing conditions in real time as much as possible. The above film thickness monitoring means 6 measures/monitors the film thickness of the wafers before the rough polishing or the finish polishing, and a film thickness measuring machine for a metal film or an oxide film may be employed according to film kinds, and in addition, the measurement principle is not limited specifically, and a film thickness measuring machine of light interference type, a four-probe ratio resistance measuring machine, a capacitance type measuring machine, an eddy current type measuring machine, an X-ray type measuring machine and the like may be employed.

Furthermore, the polishing recipe preparing means 7 prepares the polishing conditions so that the polishing conditions such as the polishing speed, the polishing pressure, the abrasives and the like become optimal, and also can prepare a plurality of optimal polishing conditions and the like separately. The polishing time forecasting means 8 forecasts the polishing time for the wafers polished under the above polishing conditions on the basis of the measured value of the above film thickness. In addition, the polishing recipe preparing means 7 can also perform the function of the polishing time forecasting means 8.

In the present embodiment, the optimal polishing conditions are divided into three polishing recipes and prepared. In the first polishing recipe, the number of polishing steps is determined, and in the second polishing recipe, the past polishing history data controlled for each module of the apparatus, that is, for each polishing shaft of the polishing heads 20A, 20B and 20C, each platen 18A, 18B and 18C, or, each combination of the polishing shafts and the platens 18A, 18B and 18C are referred to, and the polishing recipes are selected for each film thickness (each number of the laminated layers) of each polishing step and thereby the polishing conditions are prepared. Further, in the third polishing recipe, the minimal polishing time and the maximal polishing time in each polishing step are determined, and the optimal polishing conditions set at each polishing step, the polishing end point detection data and the measured value of the above film thickness are referred to, and thereby the polishing time of the wafer W (or appropriate polishing rate) is forecasted.

The above computer 9 includes a memory unit 22, a calculating unit 23, a polishing condition correcting/changing unit 24, a polishing performance index calculating unit 25, a polishing state judging unit 26, an apparatus control unit 27 and monitoring units (display units) 28 and 29. The above memory unit 22 memorizes the film thickness data (film thickness distribution graphs) measured by the film thickness monitoring means 6, polishing conditions and other past polishing history data. In addition, the temperatures of the polishing pads 19A, 19B and 19C during polishing and the temperatures of the platen 18A, 18B and 18C are input into the memory unit 22 through a temperature sensor not illustrated therein in real time. Furthermore, the calculating unit 23 compares the measured value of the above polishing time and the forecasted value thereof and calculates the difference between the values. In addition, the polishing condition correcting/changing unit 24 corrects/changes the above optimal polishing conditions in real time as much as possible so that the calculated difference becomes minimal.

The polishing performance index calculating unit 25 calculates the polishing performance indexes such as polishing uniformity, polishing rate and the like from the film thickness data and the real polishing processing time (data obtained by the polishing end point detection means) and the like. In addition, the polishing performance index calculating unit analyzes the measurement result of the film thickness of the wafers W in each polishing step, and acquires the average film thickness of the wafers W, the deviation to the above average film thickness, and the film thickness information of each specified portion of the wafers W.

The polishing state judging unit 26 compares the result value of the calculated polishing performance index and the specified value or the forecasted value, and judges the polishing state of the wafers W according to the result and outputs a judgment signal. In the present embodiment, the minimal polishing time and the maximal polishing time are forecasted and set for each individual polishing step, and the difference with the actual polishing time is evaluated and the polishing state is judged. For example, the polishing endpoint detection time and the like measured at the time of the finish polishing are input, and the difference between the measured value at the polishing end point detection time and the forecasted value is compared with a standard value, the polishing state is grasped. In addition, on the basis of the measurement result of the initial film thickness, the target film thickness and the polishing end point detection time, the actual polishing rate is calculated, and the actual polishing rate and the appropriate polishing rate forecasted beforehand are compared, and according to the result thereof, the polishing state is judged.

In accordance with the contents of the judgment signal output from the polishing state judging unit 26, the correction/change of the polishing conditions is carried out, but in this case, when the difference between the measured value and the forecasted value is within the permissible range, the polishing process of the wafers W is continued without any changes, in addition, when the difference exceeds the specified value, the calculation expression to calculate the forecasted value is changed. Furthermore, the apparatus control unit 27 controls the actions of the respective units of the apparatus by the judgment signal and the setting signal. In addition, the monitoring units 28 and 29, display on the screens the difference between the measured value of the polishing time and the forecasted value thereof, the polishing states of the wafers W, the polishing performance indexes, the polishing conditions and the like in real time.

Next, an example of the CMP process procedures of the wafer W is explained. First, the wafer W is transported to the film thickness monitoring means 6 and the film thickness measurement is performed, and after the wafer is transferred to the polishing position by the transportation unit 14A, put onto the polishing pad 19A, and it is polished by the CMP process.

The wafer W after the polishing is picked up from the platen 18A, and moved onto the platen 18C, and polishes the second film to be polished. In addition, the judgment of the above polishing end is performed by an end point detection signal from the polishing end point detection means (not illustrated). Thereafter, the wafer W is transferred to the washing/drying means 5, and washed and dried, and subsequently, it is transferred to the film thickness monitoring means 6 and the film thickness thereof is measured. By the series of processes mentioned above, the polishing of one piece of the wafer W is finished.

In the present invention, the film thickness of the wafer W is measured before the rough polishing or the finish polishing of the wafer W, and also, the optimal polishing conditions are prepared, and on the basis of the polishing conditions and the measured value and the like, the polishing time of the wafer W is forecasted. Furthermore, the actual polishing time of the wafer W that is polished under the optimal polishing conditions is measured, and the difference between the measured value and the forecasted value is calculated, and the polishing conditions are corrected/changed as soon as possible so that the calculated difference becomes minimal.

In addition, the platen at the time of the finish polishing and the platen at the time of the rough polishing may be same or different. Furthermore, it is possible to monitor the polishing removal speed and the polishing profile in real time by use of a film thickness monitoring means 6 such as a real-time optical end point detection.

The judgment whether the polishing state is normal or abnormal is made mainly by the polishing result of the optionally selected parameters, for example, the finish polishing time, but when there are expendable supplies including polishing pads, dressers, retainers, polishing heads and the like that are controlled by a counter arranged in the apparatus itself, the use time and the used polishing number of expendable supplies that the counter acquires may be used as the judgment data of the polishing state. In addition, as the judgment data of the polishing state, the temperatures of the platens and the torques of the platens and the like may also be used.

As for the result of the film thickness of the wafer W measured by the above film thickness monitoring means 6, (1) a modulus difference or a deviation (deviation of the film thickness to the average film thickness) of each polishing shaft, (2) a modulus difference or a deviation of each platen, and (3) a modulus difference or a deviation of each combination of the polishing shaft and the platen are adopted as the judgment indexes.

In the present embodiment, there are three ways as the evaluation judgment methods. In the first evaluation judgment method, the value of the polishing model which the apparatus has stored beforehand and/or an approximate expression prepared from the past polishing history and the forecasted value are compared and thereby the judgment is made. Further, in the second evaluation judgment method, the value of the polishing model which the apparatus has stored beforehand and/or a standard value calculated by the approximate expression prepared from the past polishing history and the actual polishing quantity are compared and thereby the judgment is made. In this case, the value calculated by the approximate expression may be corrected, and the data after the correction may be adopted as the judgment index. Furthermore, in third evaluation judgment method, the standard value from the approximate expression prepared from the past polishing history, and the standard value from the polishing model which the apparatus has stored beforehand are compared and thereby the judgment is made.

Next, when the judgment result is processed, the different processes are carried out according to the modulus difference or the deviation, that is, (1) in the case of the permissible level where the value of the judgment result is below a predetermined value, (2) in the case of the attention level where the same is the permission value or above and below a warning value, and (3) in the case of the warning level where the same is the warning value or above.

In the case of the permissible level of the above (1), the polishing processing is continued without any changes. In addition, in the case of the attention level of the above (2), because the difference of the film thickness (quantity of polishing) after the polishing becomes large to the target film thickness if the polishing process is continued, the polishing conditions are corrected/changed so that the difference in the film thickness becomes minimal, and the corrected/changed polishing conditions are reflected to the wafers W thereafter. Thereby, it is possible to increase the polishing precision of the wafers W thereafter. For example, by shortening the excessive polishing time, or expanding the insufficient polishing time at the finish polishing, the polishing time is adjusted into the optimal polishing time.

Further, in the case of the warning level of the above (3), an alarm is generated, and at the same time, the continuation of the polishing process is stopped immediately.

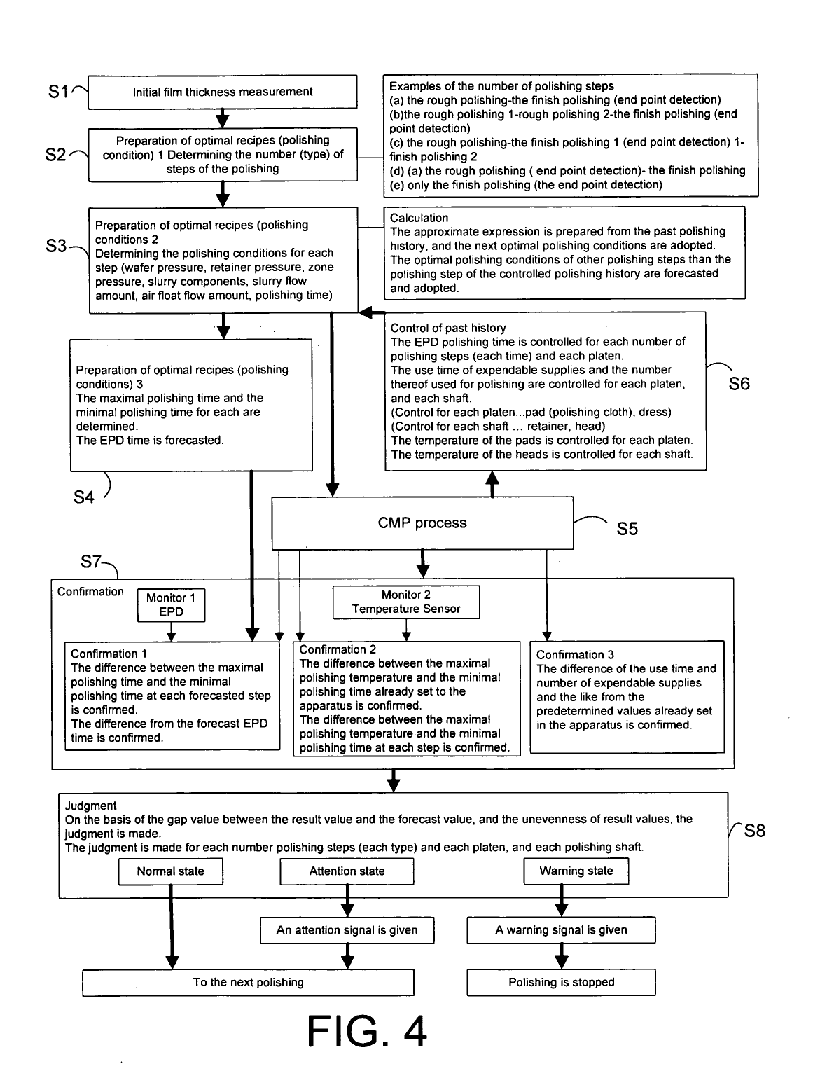

Next, an example of the polishing method according to the present embodiment is explained in detail with reference to a flow chart in FIG. 4. First, at step S1, the initial film thickness is measured by the above film thickness monitoring means 6. Next, at steps S2 to S4, optimal polishing recipes (polishing process conditions) 1 to 3 are prepared. In the preparation of the optimal polishing recipe 1, the number of steps of the rough polishing or the finish polishing (for each polishing type) is determined. For example, any of the following polishing steps (a) to (e) may be adopted optionally.

Namely, they are (a) polishing step from the rough polishing to the finish polishing (end point detection), (b) polishing step from dividing the rough polishing into two stages of rough polishing 1 and rough polishing 2 and polishing the wafer to the finish polishing (end point detection), (c) polishing step from the rough polishing to dividing the finish polishing into two stages of finish polishing (end point detection) 1 and finish polishing 2 and polishing the wafer, (d) polishing step from the rough polishing (end point detection) to the finish polishing, and (e) polishing step of only the finish polishing (the end point detection).

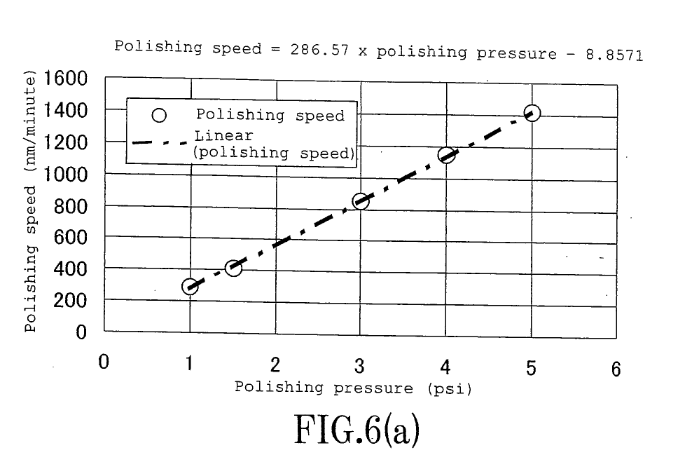

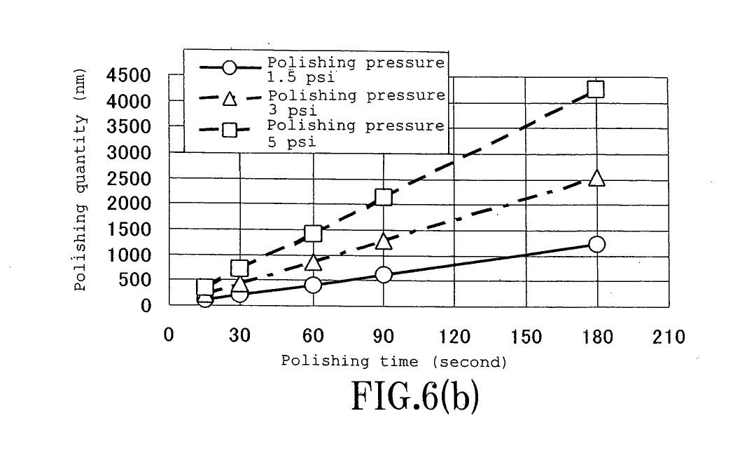

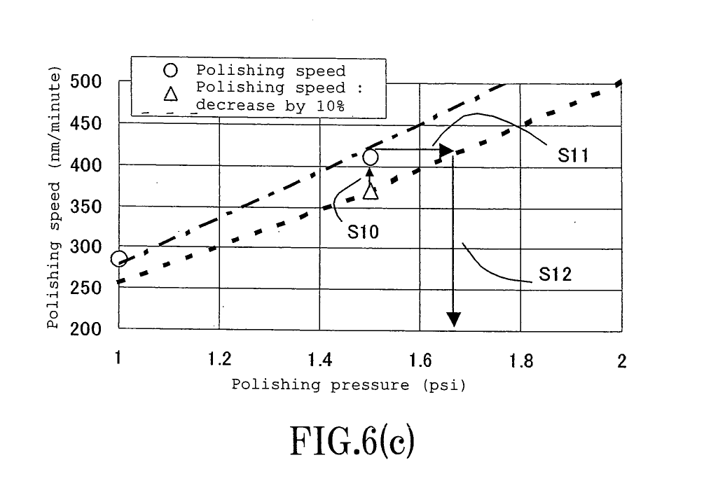

For example, as shown in FIG. 6A, by a polishing model showing the relations between the polishing pressure and the polishing quantity that are made into fixed quantities and numerical values, the polishing conditions are calculated. In FIG. 6B, the polishing model showing the relations between the polishing time and the polishing quantity that are made into fixed quantities and numerical values. In Cu polishing, when the conditions are so set as to perform the polishing within three minutes, if the measurement result of the initial film thickness of Cu is 3,600 nm, in the case when the polishing is performed at polishing pressure 3 psi in one step, the polishing speed becomes 850 nm/minute. Further, the forecasted polishing time is calculated 4 minutes 14 seconds when the initial film thickness is divided by the polishing pressure of polishing 3 psi. Further, in the case of two-step polishing where the rough polishing is performed until the Cu film thickness becomes 200 nm left, and then the finish polishing is performed, when the measurement result of the initial film thickness of the Cu is 3,600 nm, the rough polishing is performed at 3,400 nm. In this case, when the rough polishing quantity is divided by the polishing speed 1,420 nm/minute under the polishing pressure 5 psi, the forecasted polishing time of the rough polishing is calculated 2 minutes 24 seconds. Furthermore, as for the finish polishing of the remaining 200 nm, when the polishing quantity is divided by the polishing speed 411 nm/minute under the polishing pressure 1.5 psi, the forecasted polishing time of the finish polishing is calculated 29 seconds, and the total forecasted polishing time of the rough polishing and finish polishing becomes 2 minutes 53 seconds, and accordingly, it is possible to select the two-step polishing of the rough polishing and the finish polishing in which the polishing time can be shortened.

In the preparation of the optimal polishing recipe 2, the polishing conditions of each polishing step are determined. As the polishing conditions, there are, for example, the polishing time, the polishing pressures (wafer pressure, zone pressure), the polishing speed (rotation speed of the platen or the polishing shaft), the kinds or components of abrasives, the temperature of the wafer W (the temperature of the polishing head, the temperature of the platen) and the like.

In this case, an approximate expression is prepared from the controlled polishing history, or, an expression that is obtained by correcting the polishing model of the relations between the polishing quantity and the polishing time in FIG. 6B is prepared, the optimal polishing conditions of the wafers W to be polished thereafter are determined and adopted. In addition, the optimal polishing conditions of other polishing steps than the polishing step of the polishing history are forecasted. Meanwhile, in this forecast, the data of many polishing histories controlled for each polishing shaft and/or each platen, or the polishing models as shown in FIG. 6 are referred to. An approximate expression using a polynomial approximation curve is prepared typically. The above approximate expression may be prepared mainly based on the latest data. In addition, according to necessity, the value calculated by the approximate expression is corrected, and the data after the correction is adopted. For example, in the case when the polishing time of the finish polishing of the remaining 200 nm performed at the polishing pressure 1.5 psi at the moment of the two-step polishing of the rough polishing and the finish polishing is 33 seconds, the polishing speed can be obtained 363 nm/minute, and the polishing speed is lowered by approximately 10% from the polishing speed 411 nm/minute of the polishing pressure 1.5 psi. As shown in FIG. 6C, when the polishing speed is low by 10%, the target polishing speed is calculated at step 10. In addition, after the above approximate expression is obtained when the polishing speed is low by 10%, at steps 11 and 12, until the target polishing speed is obtained while the polishing speed is low by 10%, the polishing pressure is increased. Moreover, when the two-step polishing of the rough polishing and the finish polishing is selected, if the polishing time of the finish polishing becomes longer by 10%, the polishing pressure is increased until the target polishing speed is obtained. At the same time, in the rough polishing, the polishing pressure is increased until the target polishing speed is obtained.

Furthermore, in the preparation of the optimal polishing recipe 3, the maximal polishing time and the minimal polishing time are determined for each polishing shaft or each platen, or each polishing step, and the time until the polishing end point is detected (hereinafter, referred to as EPD time) is forecasted. The preparation of the optimal polishing recipe 3 is completed by the start of polishing. For example, in the case when the finish polishing of the remaining 200 nm is divided by the polishing speed 411 nm/minute at the polishing pressure 1.5 psi, and the forecasted polishing time of the finish polishing is calculated 29 seconds, as for the minimal polishing time and the maximum polishing time, 30% of the polishing time around the forecasted polishing time is added and subtracted respectively, and the minimal polishing time is determined 20 seconds, and the maximum polishing time is determined 38 seconds.

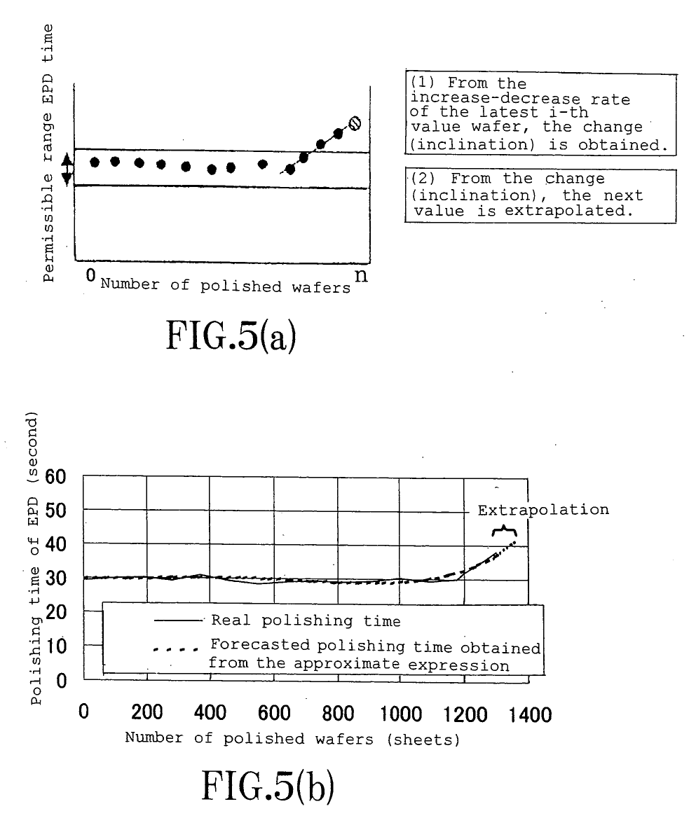

In addition, in this polishing condition control method, an approximate expression and/or a polishing model of the polishing time and the polishing quantity peculiar to the CMP apparatus are prepared, and the following optimal polishing conditions are determined and adopted. FIG. 5 are graphs showing the relations between the number of already polished wafers and the EPD time. As shown in FIG. 5A, the increase-decrease rate of the EPD time to the latest i-th (i being an integer n of 1 or higher) wafer W is obtained, and on the basis of this increase-decrease rate, the inclination in the graph, that is, the degree of changes of the EPD time to the number of the already polished wafers is obtained. Then, on the basis of the degree of changes of the EPD time, the EPD time of the next (i+1)-th wafer is obtained, and the obtained EPD time is assigned to the above approximate expression, and the forecasted value is obtained by extrapolation. In addition, as shown in FIG. 5B, on the basis of the degree of changes of the EPD time, an approximate expression using a polynomial approximation curve is prepared, and the EPD time of the next (i+1)-th wafer is obtained, and the obtained EPD time is assigned to the above approximate expression, and the forecasted value is obtained by extrapolation.

At step S5, the CMP process is started. The polishing data including the EPD time obtained by this CMP process, the use time of expendable supplies such as the polishing pads and the polishing heads and the like, the number thereof used for polishing, and the temperature of the polishing pads and the polishing heads and the like are sequentially memorized into the memory unit 22 of the computer 9, and are controlled as useful information pieces of the past polishing history (step S6). These useful information pieces are controlled for each polishing shaft, each platen, or for each polishing step. For example, the use time of the polishing pads, the dressers and/or the number thereof used for polishing are controlled for each platen, and the use time of the retainers, the polishing heads and/or the number thereof used for polishing are controlled for each polishing shaft. In addition, the temperature of the polishing pads is controlled for each platen, and the temperature of the polishing heads is controlled for each polishing shaft.

During the CMP process, the polishing progress states and the polishing temperature of the wafers W are confirmed by the monitoring units 28 and 29 in real time (step S7). That is, in the monitoring unit 28, the actual polishing time at each polishing step is monitored, and the difference (including a modulus difference or a deviation, same hereinafter) between the maximal polishing time or the minimal polishing time at each polishing step and the actual polishing time is confirmed, while the actual EPD time is monitored, the difference between the forecasted EPD time and the real EPD time is monitored.

In addition, in the monitoring unit 29, while the temperature of the polishing pad and the temperature of the polishing head are monitored, the difference from the maximal polishing temperature or the minimal polishing temperature already set in the apparatus. Further, during the CMP process, the use time and the used number of expendable supplies such as the polishing pads and/or the polishing heads and the like are monitored, and the difference from the specified values already set in the apparatus is checked. For example, when the use number of the polishing pads exceeds 2,000 pieces, a judgment to stop the polishing process is made.

At the next step S8, on the basis of the gap value between the result value and the forecasted value, and the unevenness of result values, the polishing states of the wafers W are evaluated and judged for each polishing shaft, each platen, or each polishing step. This judgment is evaluated into three states of “Normal state”, “Attention state” and “Warning state”. In the case of the “Normal state”, the polishing process is continued without any changes. Further, in the case of the “Attention state”, an attention signal is given for attention. Furthermore, in the case of “Warning state”, a warning signal is given, and the CMP process is stopped immediately. With regard to the above result value, for example, if there is unevenness by 10%, it is judged as the “Attention state”, in addition, if there is unevenness of 20%, it is judged as the “Warning state”.

Herein, when the gap value between the above result value and the forecasted value exceeds the predetermined range, the above optimal polishing conditions are corrected/changed in real time so that this gap becomes minimal. In addition, when the gap value between the result value and the forecasted value is abnormally large, the approximate expression prepared from the past polishing history and/or the polishing model used for the calculation are changed. Meanwhile, as the polishing state evaluation method, the evaluation may be made by a combination of the evaluation method in the case of the “Attention state” and the evaluation method in case of the “Warning state”. With regard to the above result value, for example, if there is unevenness by 10%, the approximate expression is remade on the basis of the unevenness by 10%.

As explained above, according to the present embodiment, the polishing conditions such as the polishing speed, the polishing pressure, the abrasives, and the like for the wafers W are prepared so as to become optimal, and the above polishing conditions are corrected/changed as soon as possible so that the difference between the measured value and the forecasted value of the polishing time of the wafers W after the polishing becomes minimal. Accordingly, the polishing conditions including the polishing speed (polishing time) and the flow quantity of abrasives and the like are always maintained appropriately, and consequently it is possible to polish the film thickness of the wafers wafer W into the target value in a minimal necessary time, and increase the polishing efficiency drastically, and also eliminate the waste of the expendable supplies such as abrasives. Furthermore, the occurrence of defective products is decreased, and consequently, it is possible to enhance the production yield substantially.

Further, since the past polishing histories are referred to for each polishing step of the wafers W, each polishing shaft or each platen, or each combination of the polishing shaft and the platen, and the optimal polishing conditions are prepared, it is possible to individually set the polishing conditions in accordance with each individual polishing step, each polishing shaft or each platen.

Furthermore, when the polishing conditions are prepared mainly on the data of the latest polishing history, the polishing conditions that put importance to the latest useful raw data are obtained, and the polishing efficiency of the wafers W improves further more. In addition, since the polishing conditions are prepared by the approximate expression prepared from the past polishing history and the data of the polishing model that the apparatus itself already has, the past polishing history and the polishing model peculiar to the apparatus are reflected to the polishing conditions, and the polishing precision is improved still more.

Moreover, when the above polishing time is forecasted on the basis of the approximate expression prepared by the past polishing history, a highly reliable forecasted time of the polishing time is obtained automatically. Still further, since the difference between the measured value and the forecasted value of the polishing time, and the polishing states of the wafers W can be monitored by use of the monitoring unit 28 and 29 in real time, it is possible to quantitatively check the polishing states of the wafers W during the polishing process.

Further, when the difference between above measured value and the forecasted value becomes the permissible value or above, an alarm signal is output automatically and when the difference is the warning value or above, a warning signal is output and the polishing process is stopped immediately. Accordingly, it is possible to prevent the wafers from being polished and processed in an abnormal state.

Furthermore, the correction/change of the above polishing conditions are performed for each polishing step of the above wafer, each polishing shaft, each platen, or each combination of the polishing shaft and the platen. Accordingly, it is possible to adjust the polishing conditions to the optimal polishing conditions corresponding to each polishing step, and also, in each polishing shaft, each platen, or in each combination of the polishing shaft and the platen, it is possible to set the optional polishing conditions in common. Thereby, eliminate the unevenness of the film thickness of the wafers among a plurality polishing steps, polishing shafts and/or platens.

The present invention can be variously modified within the scope of the present invention, and it goes without saying that the present invention comes to the modified structure.

### DESCRIPTION OF REFERENCE NUMERALS

1 CMP apparatus
4A, 4B, 4C Polishing means
6 Film thickness monitoring means
7 Polishing recipe preparing means
8 Polishing time forecasting means
9 Computer
18A, 18B, 18C Platen
19A, 19B, 19C Polishing pad
20A, 20B Polishing head
22 Memory unit
23 Calculating unit
24 Polishing condition correcting/changing unit
25 Polishing performance index calculating unit
26 Polishing state judging unit
27 Polishing condition correcting/changing unit
28, 29 Monitoring unit

What is claimed is:

1. A polishing condition control apparatus of a CMP apparatus that polishes a film to be polished formed on the surface of a wafer comprising:
a film thickness monitoring means that measures the film thickness of the wafer before polishing;
a polishing recipe preparing means that prepares polishing conditions so that the polishing conditions such as polishing speed, polishing pressure, and an abrasive and the like for the wafer become optimal;
a polishing time forecasting means that forecasts the polishing time of the wafer to be polished under the polishing conditions on the basis of the measured value of the film thickness;
a polishing time measuring means that measures the polishing time of the wafer polished under the polishing conditions; and
a computer that controls the measurement results of the polishing time and the polishing conditions, wherein
the computer includes a calculating unit that calculate the difference between the measured value of the polishing time and the forecasted value thereof, and a polishing condition correcting/changing unit that corrects/changes the polishing conditions so that the calculated difference becomes minimal, and thereby,
the correction/change of the polishing conditions are carried out in real time.

2. The polishing condition control apparatus of a CMP apparatus according to claim 1, wherein the polishing recipe preparing means prepares the optimal polishing conditions for each polishing step of the wafer, each polishing shaft of the CMP apparatus, each platen, or each combination of the polishing shaft and the platen.

3. The polishing condition control apparatus of a CMP apparatus according to claim 1 or 2, wherein the polishing recipe preparing means prepares the optimal polishing conditions on the basis of data of an approximate expression prepared from past polishing history and/or a polishing model that the CMP apparatus itself stores beforehand.

4. The polishing condition control apparatus of a CMP apparatus according to claim 1, wherein the polishing time forecasting means forecasts the polishing time of the wafer on the basis of data of an approximate expression prepared from past polishing history and/or a polishing model that the above CMP apparatus itself stores beforehand.

5. The polishing condition control apparatus of a CMP apparatus according to claim 1, wherein the computer has a monitoring unit that displays the difference between the measured value of the above polishing time and the forecasted value thereof, and polishing states of the above wafers and the like.

6. The polishing condition control apparatus of a CMP apparatus according to claim 1 or 5, wherein the computer includes a polishing state judging unit that outputs an attention signal, an alarm signal and/or a polishing stop signal when the difference between the measured value of the polishing time and the forecasted value thereof exceeds a predetermined value.

7. The polishing condition control apparatus of a CMP apparatus according to claim 1, wherein the polishing condition correcting/changing unit corrects/changes the polishing conditions for each polishing step of the wafer, each polishing shaft of the above CMP apparatus, each platen, or each combination of the polishing shaft and the platen.

8. A polishing condition control method of a CMP apparatus that polishes a film to be polished formed on the surface of a wafer comprising:
a film thickness monitoring step that measures the film thickness of the wafer before polishing;
a polishing recipe preparing step that makes polishing conditions so that the polishing conditions such as polishing speed, polishing pressure, an abrasive and the like for the wafer become optimal;
a polishing time forecasting step that forecasts the polishing time of the wafer to be polished under the polishing conditions on the basis of the measured value of the film thickness;
a polishing time measuring step that measures the polishing time of the wafer polished under the polishing conditions,
a calculating step that calculates the difference between the measured value of the polishing time and forecasted value; and
a polishing condition correcting/changing step that corrects/changes the polishing conditions so that the calculated difference becomes minimal, wherein
the correction/change of the polishing conditions are carried out in real time.
